(19) United States
(12) Patent Application Publication
(10) Pub. No.: US 2007/0257142 A1
(43) Pub. Date: Nov. 8, 2007

(54) Coffee grinder and improved method of grinding coffee to prevent wastage

(76) Inventor: Cornelius A. Chapman, Brooklyn, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/417,748

(22) Filed: May 4, 2006

(51) Int. Cl. B07B 13/00

(52) U.S. Cl. 241/92

(57) ABSTRACT

A process for grinding coffee beans to insure that only the amount of coffee beans necessary to brew a desired amount of coffee are ground, and that the remaining beans are not ground, but rather saved for future use.

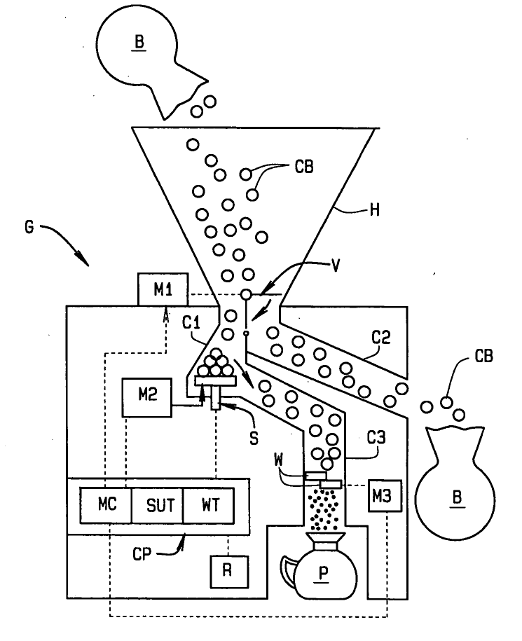

### CROSS REFERENCE TO RELATED APPLICATIONS

Provisional application 60/664,070 filed Mar. 22, 2005

### STATEMENT REGARDING FEDERALLY SPONSORED RESEARCH OR DEVELOPMENT

N/A.

### BACKGROUND OF THE INVENTION

This invention relates to grinding coffee in coffee houses, restaurants, and the like, and more particularly, to an improved method of weighing out and then grinding only the amount of coffee beans actually required to be brewed at one time, so the coffee beans are not wasted.

The coffee served in popular coffee shops or coffee bars such as Starbucks®, restaurants and similar establishments is typically ground on-site. For this purpose, bags of coffee beans of a predetermined weight (2, 5, or 10 pounds, for example) are provided. When coffee made from a particular type bean is brewed, a bag of beans is opened and the contents poured into a coffee grinder which grinds all of the beans at one time. The ground beans are then placed in a coffee pot and the coffee brewed.

A problem arises because oftentimes it is not necessary to grind all of the coffee beans to brew the amount of coffee that will be consumed. This is particularly true with certain coffees which are not consumed to the same degree as other coffees. In these instances, the unused coffee which is brewed goes to waste because it does not remain as fresh as consumers may want it. Typically, once a bag of coffee beans is opened, they are all ground and brewed, even the coffee is not drunk, because the ground beans will otherwise turn rancid and cannot be used. If the person grinding the coffee beans realizes that more beans have been ground than are needed to make a batch of coffee, he typically must scoop out the amount of grounds that will not be needed and throw them away. This problem is made more difficult by the fact that many grinders have only one setting for grinding. If more beans are ground than are needed, the remaining beans can clog up the machine. This then necessitates manually taking the grinder apart and cleaning and brushing it out, so that ground beans for one type of coffee do not get intermixed with the beans for another type of coffee, and spoil its taste. In addition, if the person brewing coffee is not careful, more beans than are necessary can be used in brewing a batch of coffee. This both affects the taste of the brewed coffee, but also can cause a pot to overflow, again necessitating a clean-up.

Coffee grinders typically used in these establishments are designed to grind a batch of coffee beans previously weighed and bagged. Once put in the grinder, all the beans poured into the hopper feeding the grinder are ground. If excess beans are ground, they are usually wasted. A complicating factor is that the person responsible for grinding the beans and brewing the coffee often does not have time to worry about how much coffee to make, particularly during the peak business times which occur in the morning, and around lunch or dinner time. Rather, the person simply must grind all the beans in a bag and hope that all the ground beans are used because of the demand for coffee made from that particular type of bean.

U.S. Pat. No. 4,645,132 describes a method for use in a coffee grinder which first grinds, and then weighs the ground beans. Any ground beans in excess of the measured amount are transferred back to a coffee bag. While the invention may work for its intended purpose, it would better to first weigh the beans and then grind the amount desired, since the unground beans are less likely to quickly turn rancid than the ground beans.

### BRIEF SUMMARY OF THE INVENTION

The present invention is directed to a method by which only the amount of coffee beans required to brew a desired amount of coffee are ground in a coffee grinder, regardless of the amount of beans stored in a bag. The method employs using a coffee grinder having a means for measuring a desired weight of beans from a bean container, prior to grinding the beans, so only the required amount of beans are ground. If the entire contents of a bag are poured into the grinder, then the quantity of beans, over and above the amount weighed, are poured back into a container for future grinding.

Prior to pouring the coffee beans into a grinder, an operator sets the amount of beans, by weight, that are required to be ground. The coffee beans are then poured into a hopper where they are deposited upon a scale. Once the preset weight of coffee beans are weighed, the remaining beans are directed back to the original or another container for future grinding. The measured quantity of weighed beans are then ground and the ground beans used to make coffee. This process insures that only the necessary amount of beans are ground, and that no coffee beans are wasted.

Other objects and features will be in part apparent and in part pointed out hereinafter.

### BRIEF DESCRIPTION OF THE DRAWINGS

The sole figure of the drawings is a representation of a coffee grinder and brewing machine in accordance with the invention

### DESCRIPTION OF THE INVENTION

Referring to the sole drawing figure, a coffee grinder G grinds coffee beans cb poured into a hopper H of the grinder from a bag B or other package or container of the beans. The unground beans cb flow through the hopper and onto an internal scale S of the grinder through a channel C1 located at the bottom of the hopper. Channel C1 is opened and closed by a valve V operated by a motor M1. A set of controls on a control panel CP allow an operator to preset the weight of coffee beans cb to be ground. For this purpose, a control SET on the panel is used by the operator to enter the desired weight.

As the beans drop onto the scale the weight of beans increases. The measured weight of beans is provided to a control WT on panel CP. When the weight of measured coffee beans on the scale equals the preset value, a motor control MC activates motor M1 to move valve V to close channel C1. This is done by the motor rotating valve V in the clockwise direction shown in the drawing.

Rotating valve V to close channel C1 simultaneously opens a second channel C2. All the coffee beans now poured into the hopper are diverted through channel C2 and are not ground. Rather they are poured into another coffee bag B or package or container for later weighing and grinding. At the same time valve V closes channel C1 and opens channel C2, motor control MC activates a second motor M2 to rock scale S in the clockwise direction indicated by the arrow. The weighed coffee beans cb on scale S now pour into and flow through another channel C3. A set of grinding wheels W are positioned in this channel. These wheels are operated by a motor M3 which is activated by motor control M3 to now grind the weighed beans into flakes which then pour into a coffee pot P for subsequent brewing. There are a number of advantages to the above described process.

First, only a specified amount of coffee beans are ground for the amount of coffee to be brewed. There are no leftover beans or beans, which, even though ground, are not immediately used and can go rancid.

Second, the ground beans brewed to make the coffee will be fresh when used, improving the flavor of the coffee.

Third, the grinding operation is clean. There is little or no mess which must be cleaned up when the grinding operation is complete. This is especially important during peak business times when an operator has more important things to do than dismantle and clean a grinder.

Fourth, because grinder G is used to grind only a specified amount of coffee beans, rather than all the ground beans in a bag B, this is particularly useful where a number of coffee pots P are located throughout a restaurant or store. Now, the specified amount of beans required for each pot can be ground, for one pot after another, and then immediately taken to the station where the pots are located, for brewing. Again, this prevents wastage and eliminates spoilage. In addition, the weight of beans for each pot can be changed from one grinding operation to the next, so if different sized pots are used at the different stations, the correct amount of beans can be ground for each pot.

Fifth, the coffee grinder can be operated remotely so someone does not have to be standing by the machine throughout a coffee grinding operation.

Sixth, coffee grinders usually have only has one spout from which coffee beans are dispensed. Thus an operator can only put coffee beans for one flavor at a time to be ground. Although not shown in the drawing, my new coffee grinder can be equipped with multiple (up to four) separate grinding sections, so coffee bags for more than one flavor can be ground at the same time. The overall operation with regard to each section is the same as described above.

In addition to the above, with my new coffee grinder G, someone can pour a lot of coffee beans cb into the grinder, with the grinder automatically determining the weight of the coffee beans, as previously described. By programming the grinder, the operator further can now tell how many bags B of coffee beans are to be ground. This can be done regardless of whether all of the bags are to have same weight of beans, or if different bags B are to be filled with different weights of beans. The operator can also program coffee grinder G as how many bags of coffee one wants according to the weights of the bags; e.g., two bags filled with five pounds, two more bags filled with two pounds, etc. The bags can be separately identified by the operator as to the weight of beans with which they are filled, and this information is stored in a memory R of the grinder. Information can also be stored in memory R as to the type of coffee bean stored in each bag. Accordingly, the grinder can be used to separate different flavors of whole beans by whatever weight you want without grinding any coffee. Then, if the operator wants, he can dispense whole, weighed coffee beans out of the grinder into bags B before the grinder starts grinding the coffee beans needed right then. In addition to the above, memory R can also be programmed to tell the operator how many cups of coffee one can make using different weights of coffee beans.

Used in this way, grinder G can be used to more efficiently to grind the beans. Since the weighed contents of each identified bag is stored in the machine's memory, the grinder already has the information it needs to subsequently grind the beans in an identified bag. When it is time to grind the beans in a previously identified bag, the operator simply enters the bag identification information, and grinder G will know both the weight of beans to be ground, as well as the type of beans. Otherwise, if grinder G grinds the coffee beans before it weighs them, then one doesn't have any choice as to how many bags the grinder can be programmed to grind at one time, and one would have to wait until the beans are ground before one retrieve and store any leftover whole coffee beans.

The memory feature of coffee grinder G also has other memory settings not found in previous coffee grinders. For example, one can program all the different types of coffee beans to be ground in the grinder including both their weight settings and grind settings. Also, the operator can program the number of bags needed for each flavor of coffee.

In coffee shops, throughout the day, business rises and falls. In the morning, after breakfast time, business is typically slow; but by lunch, business again peaks. After lunch, business typically falls again. With my new coffee grinder G, one can program the times of day when more or less coffee needs to be ground.

In view of the above, it will be seen that the several objects and advantages of the present invention have been achieved and other advantageous results have been obtained.

Having thus described the invention, what is claimed and desired to be secured by Letters Patent is:

1. A coffee grinder comprising:
a hopper into an inlet of which is poured coffee beans, the beans flowing through the hopper to an outlet thereof;
a scale positioned at the outlet and onto which the coffee beans fall, the scale weighing the coffee beans;
control means responsive to the scale measuring a predetermined weight of coffee beans to operate a valve movable into a position to divert the flow of coffee beans from the scale when the predetermined weight of coffee beans has been measured by the scale; and,
grinding means to which the coffee beans on the scale are directed by the control means for grinding the measured amount of coffee beans, the ground beans being then deposited in a coffee pot for the ground beans to be used to make a pot of coffee, weighing a predetermined amount of coffee beans allowing only a required amount of coffee beans to be ground for a required amount of coffee to be brewed.

2. The coffee grinder of claim 1 further including a channel into which coffee beans flowing through the hopper are diverted when the control means moves the valve, the coffee beans so diverted being stored for later grinding.

3. The coffee grinder of claim 2 further including a second channel into which the coffee beans on the scale are deposited after the predetermined amount thereof is weighed for delivery to the coffee pot, the grinding means being interposed in the second channel to grind the coffee beans.

4. The coffee grinder of claim 1 further including a memory means programmed to tell an operator of the coffee grinder how many cups of coffee one can make for different weights of coffee beans.

5. The coffee grinder of claim 2 in which the control means facilitates different weights of coffee beans to be successively measured for brewing different amounts of coffee.

6. The coffee grinder of claim 1 having a plurality of hoppers and grinders for simultaneously weighing and grinding different amounts of coffee beans of the same or of a different variety of bean.

7. An improved method of grinding coffee beans comprising:
predetermining the amount of coffee beans needed to be ground to make a predetermined amount of coffee;
pouring coffee beans from a container therefore into a coffee grinder and weighing the beans;
after the predetermined amount of coffee beans is weighed, diverting the flow of additional coffee beans to a container in which the beans are saved for future grinding; and,
grinding the coffee beans which have been weighed and delivering the ground beans to a coffee pot for brewing the predetermined amount of coffee.

8. The method of claim 7 further including programming a memory means to tell an operator of the coffee grinder how many cups of coffee one can make for different weights of coffee beans.

9. The method of claim 8 for simultaneously weighing a grinding different amounts of coffee beans for brewing different amounts of coffee.
